(19) United States
(12) Patent Application Publication
(10) Pub. No.: US 2014/0084665 A1
(43) Pub. Date: Mar. 27, 2014

(54) MATERIAL TRANSFER APPARATUS FOR A GROUND MILLING MACHINE, AND A GROUND MILLING MACHINE, ESPECIALLY ROAD MILLING MACHINE, HAVING SUCH A MATERIAL TRANSFER APPARATUS

(71) Applicant: BOMAG GMBH, Boppard (DE)

(72) Inventors: Karl-Hermann Môtz, Munchen (DE); Markus Meurer, Sinzig (DE)

(73) Assignee: BOMAG GMBH, Boppard (DE)

(21) Appl. No.: 14/017,550

(22) Filed: Sep. 4, 2013

(30) Foreign Application Priority Data
Sep. 26, 2012 (DE) 10 2012 019 016.6

(51) Int. Cl. B65G 37/00; E01C 23/088; E01C 23/12

(52) U.S. Cl. CPC B65G 37/00; E01C 23/127; E01C 23/088
USPC 299/39.2; 198/606

(57) ABSTRACT

The present invention relates to a material transfer apparatus for a road construction machine, and especially a ground milling machine. The material transfer apparatus comprises a material feed area, a material discharge area and a sealing apparatus. According to one aspect of the present invention, the sealing apparatus comprises a first sealing element and a second sealing element, wherein the first sealing element and the second sealing element overlap each other at least in part and form a hollow space, so that ground material to be removed is conveyed in an unobstructed manner from the material feed area to the material discharge area.

### CROSS-REFERENCE TO RELATED APPLICATIONS

The present application claims priority under 35 U.S.C. §119 of German Patent Application No. 10 2012 019 016.6, filed Sep. 26, 2012, the disclosure of which is hereby incorporated herein by reference in its entirety.

### FIELD OF THE INVENTION

The present invention relates to a material transfer apparatus for a ground milling machine, especially a road milling machine, for transferring milled ground material. The material transfer apparatus comprises a material feed area of a transfer conveyor belt, a material discharge area of a loading conveyor belt, and a sealing apparatus with a first sealing element. The present invention further relates to a road construction machine, especially a road milling machine.

### BACKGROUND OF THE INVENTION

A generic ground milling machine, especially a cold road milling machine, is known from WO 2010/045952 A1, for example, wherein reference is hereby made to its disclosure concerning the configuration and the principal functionality. Such a construction machine comprises a milling drum mounted on a machine frame, which drum will enter the ground to be milled in working operation. The milling drum will rotate about its rotational axis, which is situated transversely to the working direction in a horizontal plane. The milled ground material will be collected in a milling drum box and conveyed from there via a first conveyor belt (transfer conveyor belt) through the machine in the working direction to the front to a second conveyor belt (loading conveyor belt) attached to the machine frame and is ejected via an ejection area of the loading conveyor belt into a transport vehicle or onto a track adjacent to the machine. The loading conveyor belt is adjustably mounted on the machine frame and can be swivelled upwardly and downwardly starting from a zero position, and/or can be pivoted to the sides of the machine.

It is desirable for a smooth working process to remove the milled material as completely as possible in order to reduce subsequent cleaning and clearing work, for example. If the transport system for the transport of the milled material from the milling point to the ejection point comprises two conveyor belts arranged behind one another in the direction of transport, the position at which the milled material is transferred from the one conveyor belt to the other conveyor belt represents an especially sensitive point. Up until now this area of the material transfer is separated by a vertically suspended rubber mat or a plurality of rubber elements, similar to a curtain, and is partly sealed towards the outside. In many cases this mat will also be used as an impact element, against which the milled material will strike when coming from the material feed area of the transfer conveyor belt and will subsequently drop onto the material discharge area of the loading conveyor belt and will be transported to the ejection area of the loading conveyor belt.

It is disadvantageous that by braking the milled material on the rubber elements they are subject to a high level of wear and tear, and there is further an additional development of dust by the rebounding milled material. Considerable leakages in the region of the material transfer point are a further disadvantage in known material transfer points, so that dust and partly fragments of milled material will exit to the outside from the material transfer point. The fact that the rubber mats can only be arranged suspended from above due to the high degrees of freedom of the outer conveyor belt (lifting/lowering and lateral pivoting to the left and right) leads to the consequence that this area cannot be sealed sufficiently. As a result, milled material and milled dust will escape, which represents a serious health hazard for the operating staff of the road construction machine.

### SUMMARY OF THE INVENTION

The present invention is therefore based on the object of providing a material transfer apparatus and a road construction machine in which a secure transfer of material occurs from a conveyor belt to a conveyor belt situated downstream in the conveying direction, and simultaneously the development of dust occurring during the transfer is reduced. The conveying direction is the direction in which the milled material is conveyed from the milling point up to the ejection of the milled material. The material transfer apparatus should additionally ideally have a low-wear configuration and provide good sealing results even in the case of different pivoting positions of the loading conveyor belt in relation to a zero or starting position.

One aspect of the present invention lies in the finding that by combining at least two sealing elements it is possible to achieve improved sealing results for the transfer space from the transfer conveyor belt to the loading conveyor belt. Specifically, in accordance with one embodiment of the present invention, the sealing apparatus comprises at least one second sealing element in addition to the first sealing element, wherein the first sealing element and the second sealing element partly overlap one another at least in part and form a hollow space and seal the same to the outside at least in part, through which milled ground material to be discharged is conveyed in an especially unobstructed manner from the material feed area to the material discharge area. In other words, it is provided in accordance with one aspect of the present invention that, with at least two sealing elements, a transfer space is enclosed at least in part in which the transfer of the milled material occurs from the transfer conveyor belt to the loading conveyor belt. The milled material will fall within this transfer space preferably directly from the material feed area of the transfer conveyor belt to the material discharge area of the loading conveyor belt without being deflected, for example, by an impact element or a comparable material guide device. A sealing element is a component which can also comprise several parts and via which a spatial boundary is created in at least one spatial direction, so that a barrier for dust is obtained, for example. The hollow space concerns a space which is delimited at least partly to the outside by the at least two sealing elements. The two sealing elements are therefore arranged in the manner that they partly enclose an inner compartment in which the transfer of the milled material occurs from the transfer conveyor belt to the loading conveyor belt. The sealing elements are preferably arranged in the manner that they enable a sealing upwardly in the vertical direction and at least partly in the horizontal direction to the side (with respect to the working direction of the ground milling machine). The magnitude of this transfer space bordered by the two sealing elements depends among other things on the path of movement, especially the trajectory, of the milled material between the end of the transfer conveyor belt (material feed area) and the beginning or the material receiving point on the loading conveyor belt (material discharge area). This region of the material transfer is overcome at least partly in a trajectory due to, among other things, the kinetic energy which the milled material has as a result of the movement on the inner conveyor belt. Ideally, this trajectory of the material flow will be exploited in order to convey the milled material as far as possible in the desired direction. The use of wearing impact elements will be preferably avoided, so that preferably there will be a direct transfer of milled material from the transfer conveyor belt to the loading conveyor belt. This offers the advantage that the milled material will not be braked at the transfer point. Less dust is produced in this process in the transfer area and the milled material will be swirled to a lower extent. A lower material ejection in form of dust to the ambient environment means a clean milling surface and therefore less effort and lower costs in order to leave an optimal milling surface. In addition, the reduction of the dust considerably lowers the health risk for a machine operator.

An adjustment of the position, especially of the loading conveyor belt, to the specific loading situation is often desirable in working operation in order to enable the optimal position of the loading conveyor belt for different loading scenarios (unloading on a transport vehicle, unloading on the ground, etc). As a result of the resulting change in the relative position of the transfer conveyor belt to the loading conveyor belt or the material feed area to the material discharge area, it is advantageous when a respective adjustment of the sealing apparatus, and, in particular, the arrangement of the hollow transfer space, is enabled. It has proven to be advantageous in this respect when the sealing apparatus is arranged in the manner that the two sealing elements are displaceable relative to one another. This allows easy adjustment to changes in the positioning of the orifice areas (material feed area and material discharge area) of the material transfer apparatus which are caused by changes in position, especially of the loading conveyor belt.

A broad spectrum can principally be used concerning the specific spatial arrangement of the at least two sealing elements. It is ideal if the two sealing elements are arranged in the manner that they can be moved against each other at least in part without impairing the sealing properties. This can be achieved by a shaping of the first and the second sealing element which is adjusted at least partly with respect to each other, especially in the manner that the two sealing elements have the same shape at least in part in the overlapping region, even though also partly with larger or smaller dimensions. The arrangement of the first and the second sealing element at least partly substantially in form of a spherical cap or calotte has proven to be ideal in this context. A spherical cap shall designate a shape in the present case which originates from a hollow sphere section, especially with one single sectional plane, wherein slice-like shapes are also included in the present case, e.g., in the form of a quarter sphere which is obtained by a spherical section with two sectional planes. In this respect, it is not necessary that the entire sealing element is completely arranged in form of a spherical cap. What is important is that especially the mutually overlapping, and especially mutually touching, regions of the first and the second sealing element are respectively substantially arranged as a spherical cap, especially over the entire region of their adjustable relative positions with respect to each other. The form of a spherical cap offers the advantage that it has the same properties concerning its surface and curvature in different spatial directions originating from a starting point in a specific area depending on the size of the spherical cap, so that in the case of different relative positions of the first and the second sealing element the sealing properties between the two elements will remain the same in the region of overlapping parts of the respective spherical cap.

Three-dimensionally deformed sealing elements are therefore provided, which have the shape of a spherical cap at least in part and enclose a hollow space or transfer space at least in part in which the transfer of the milled material can occur from the material feed area of the transfer conveyor belt to the material discharge area of the loading conveyor belt. It is ideal if the spherical cap of the one sealing element is arranged at least partly and especially to relevant parts in the interior of the other spherical cap of the other sealing element. Especially good sealing results are achieved in this manner. Specifically, the one spherical cap protrudes with its bulged portion into the interior space formed by the bulged portion of the other spherical cap, so that the outside of the inner spherical cap is oriented towards the inner surface of the outer spherical cap.

A spherical cap is defined in its spatial configuration among other things by its radius and the position of its centre point which corresponds to the hollow sphere underlying the spherical cap. A configuration and arrangement of the two spherical caps of the first and the second sealing element have proven to be especially preferable in accordance with one embodiment of the present invention in the manner that the two spherical caps of the two sealing elements have a common centre point. Since the one spherical cap is to be arranged at least partly in the interior of the other spherical cap, the radii of the two sealing elements differ in this embodiment. The sealing element with the larger radius forms the element situated on the outside and the sealing element with the smaller radius is the sealing element which is arranged at least partly in the interior of the other sealing element. This arrangement comes with the advantage that the two sealing elements can be adjusted about the common centre point with respect to each other in their relative position or twisted with respect to each other without changing the sealing properties, at least within a fixed adjusting area, which depends on the size and the spatial extension of the two spherical halves.

The loading conveyor belt of the ground milling machine frequently concerns a so-called suspension conveyor belt. It is attached to a machine frame of the ground milling machine and can be adjusted in its height and/or lateral position for respectively adjusting the loading position. In other words, the loading conveyor belt can be pivoted about a horizontal axis in relation to the machine frame in order to change the height of the ejection area of the loading conveyor belt, for example, and/or be pivoted about a vertical axis in order to change the lateral alignment of the position of the ejection area of the loading conveyor belt, for example. It is now preferable if the material discharge area (or the loading conveyor belt) can pivoted upwardly or downwardly about an adjusting axis relative to the material feed area (or the transfer conveyor belt), wherein the common centre point lies on this substantially horizontal axis. These variants are based on the finding that an adjusting area is obtained by a positioning of the spherical caps with their centre points on at least one of the pivoting axes, in which the sealing conditions of the two spherical caps are constant with respect to each other (as long as the two spherical caps overlap each other at least in part) since the spherical caps will be adjusted with respect to each other about their centre point and consequently their distance in the radial direction will remain constant in different adjusting positions.

An adjustment of the sealing apparatus is especially advantageous when the loading conveyor belt on the ground milling machine is changed in its position, e.g., by lateral pivoting and/or by changing the angle of attack of the conveyor belt. This leads to a change in the relative position of the material feed area to the material discharge area. In order to achieve the simplest possible, and ideally automatic, adjustment of the sealing apparatus or especially the positioning of the first sealing element relative to the second sealing element, the first sealing element is preferably fixed to the machine frame and the second sealing element to the loading conveyor belt, especially a frame element of the loading conveyor belt. The pivoting of the loading conveyor belt automatically simultaneously achieves a pivoting and adjustment of the position of the second sealing element in relation to the first sealing element, so that no separate adjustment of the sealing apparatus is required, for example.

Principally, the first and/or the second sealing element can be made of several substructure parts, wherein it is preferable if at least the area of the hemi-spherical shell of the first and/or the second sealing element is integral and massive. In addition to the arrangement of the hemi-spherical shell, there can be further elements such as fastening and/or sealing elements which ideally are also integrally arranged with the first and/or the second sealing element in order to facilitate the mounting of the sealing elements, in particular.

The object of the present invention is further achieved by a ground milling machine, especially a road milling machine, comprising a transfer conveyor belt for conveying milled material from a milling drum box to a loading conveyor belt, the loading conveyor belt for conveying the milled material to an ejection point and a material transfer point at which the material is transferred from the transfer conveyor belt to the loading conveyor belt. For achieving the object in accordance with the present invention, the ground milling machine comprises a material transfer apparatus as described above at the material transfer point from the transfer conveyor belt to the transport conveyor belt. It is advantageous especially in road milling machines to minimise the development of dust to the highest possible extent because a number of workers will work on or close to the road milling machine in working operation. The present invention can principally be applied to all generic road milling machines, wherein an application on rear or middle rotor milling machines of the front-loader type has proven to be especially suitable.

### BRIEF DESCRIPTION OF THE DRAWINGS

The present invention will be explained below in closer detail in the drawings especially by reference to an embodiment. The present invention is not limited to this embodiment however, so that other combinations and applications are possible and are included in the present invention. In the schematical drawings:

FIG. 1 shows a side view of a generic road milling machine;

FIG. 2 shows a partial sectional view of the side of a road milling machine with a material transfer apparatus in accordance with one aspect of the present invention;

FIG. 3 shows a detailed view of the material transfer apparatus of FIG. 2;

FIG. 4 shows a cross-sectional view of the material transfer apparatus of FIG. 2 in accordance with one aspect of the present invention;

FIG. 5 shows a detailed view of the material transfer apparatus of FIG. 4; and

FIG. 6 shows a schematic side view of a material transfer apparatus in accordance with one aspect of the present invention for illustrating the structural principle and the functionality.

### DETAILED DESCRIPTION OF THE INVENTION

All drawings are schematic and shall be understood as not being true to scale. Similar or identical elements are designated in the drawings with the same reference numerals.

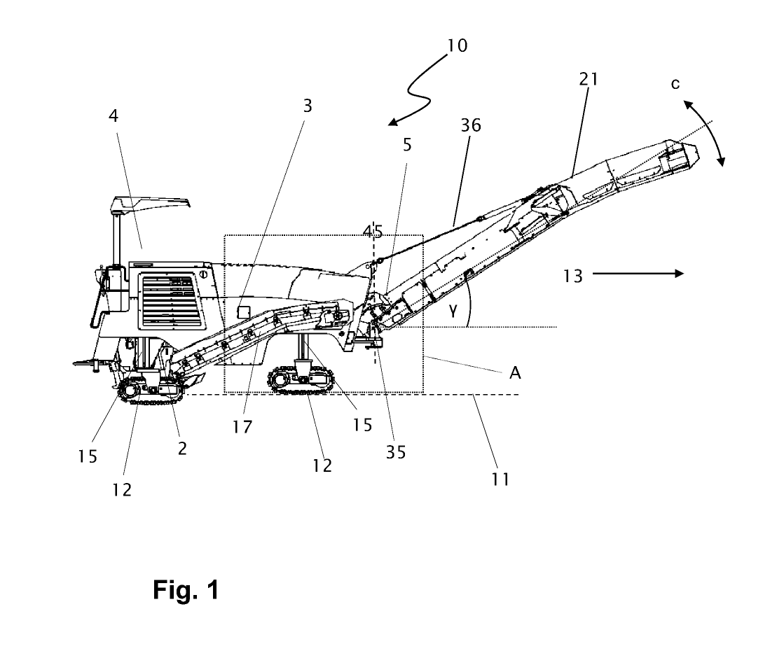

FIG. 1 relates to a generic ground milling machine 10 as known in the prior art. The ground milling machine 10 according to FIG. 1 specifically concerns a road milling machine of front-loader type with rear rotor in a side view. The ground milling machine 10 travels in the forward direction 13 in working operation (the reverse direction is designated with reference numeral 14), wherein a milling drum, which is not shown in closer detail, is held in a milling drum box 2 and enters the ground 11 to be milled. The milling roller rotates about a horizontal rotational axis extending transversely to the working direction. Further relevant elements of the ground milling machine are a machine frame 3 with an operator platform 4 and crawler tracks 12 which are mounted in a height-adjustable manner by means of lifting columns 15 (the travelling elements of the ground milling machine 1 are therefore crawler tracks in FIG. 1, wherein wheel chassis could also be used alternatively; FIG. 1 only shows the crawler tracks arranged on the right side). The ground milling machine 10 further comprises a milling rotor drive device (not shown in closer detail), which in the present case is an internal combustion engine, by means of which the working power is provided that is necessary for operation. A drive gear, which is not designated in closer detail, is provided for power transmission.

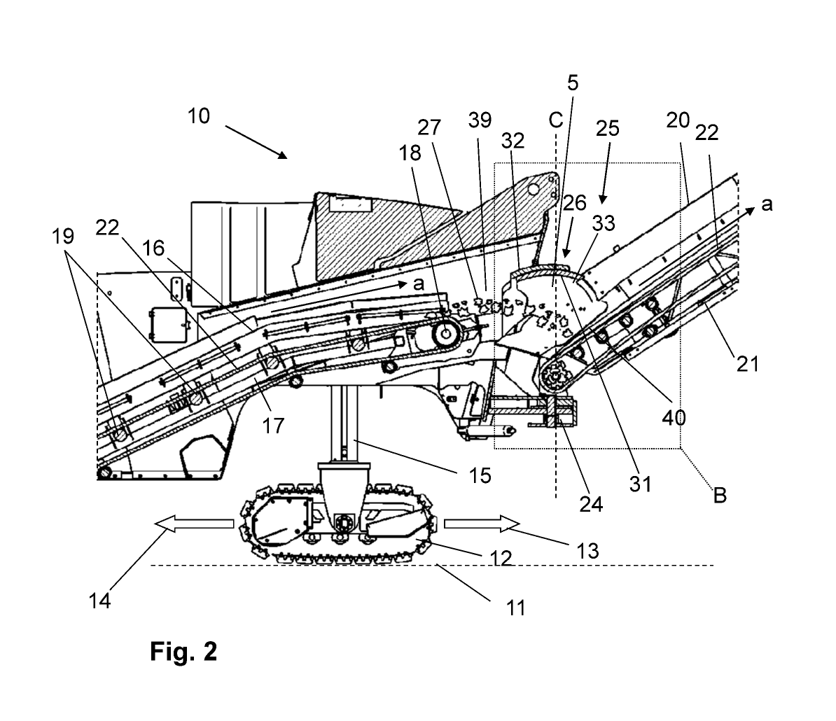

An essential aspect in the operation of the ground milling machine 10 is the removal of the milled material from the milling area. For this purpose, the ground milling machine comprises two conveyor belts which are arranged one behind the other in the conveying direction, specifically a transfer conveyor belt 17 and a loading conveyor belt 21. The transfer conveyor belt 17 receives milled material collected in the milling drum box 2 and conveys it through the interior of the machine in the working direction to the front. The loading conveyor belt 21 is adjacent to the transfer conveyor belt 17 in the conveying direction, which loading conveyor belt receives the milled material unloaded by the transfer conveyor belt 17 and advances the same. The loading conveyor belt 21 concerns a so-called attachment conveyor belt. The loading conveyor belt 21 is attached in the front region of the machine frame 3 via a suspension 24 (FIG. 2) and is movable in relation to the machine frame 3 via an adjusting device 36 which is not described in closer detail. As a result, the loading conveyor belt 21 can be adjusted, for example, about a horizontal swivel axis 35 (perpendicularly to the viewing plane in FIG. 1) in its angle of attack y in the direction of arrow c in order to enable the adjustment, for example, of the ejection height of the loading conveyor belt 21 to different loading situations. Adjustment of loading conveyor belt 21 in its position in relation to the machine frame 3 can also occur laterally about the vertical swivel axis 45, so that the machine operator can choose between a middle position or a position of the loading conveyor belt 21 which is pivoted to the right or left. It has now been noticed in working operation of the ground milling machine 10 that especially the transfer point of the milled material between the transfer conveyor belt 17 and the loading conveyor belt 21 is a source of massive dust development, which is a serious burden on the machine operator and the persons accompanying the ground milling machine 10 in working operation. This is caused, in particular, by the fact that a material guide device such as an impact plate was hitherto arranged in this area, wherein the milled material arriving from the transfer conveyor belt 17 is ejected against said impact plate and will subsequently drop onto the loading conveyor belt 21. The present invention now proposes arranging this region in the manner as explained below, by way of example, in order to especially improve the material flow of the milled material and to prevent the production of dust in the transfer region.

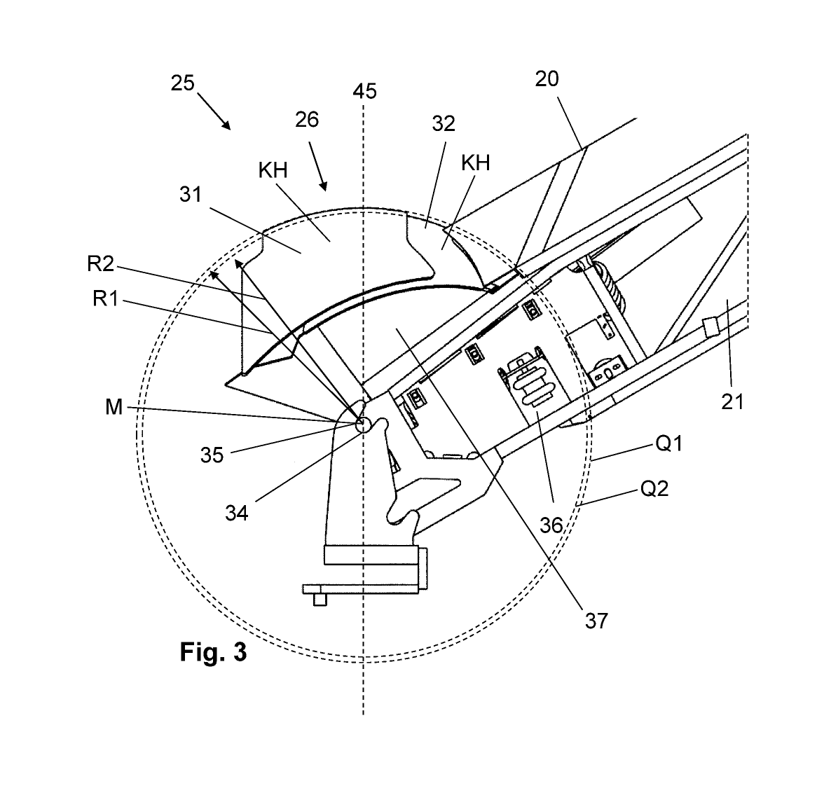

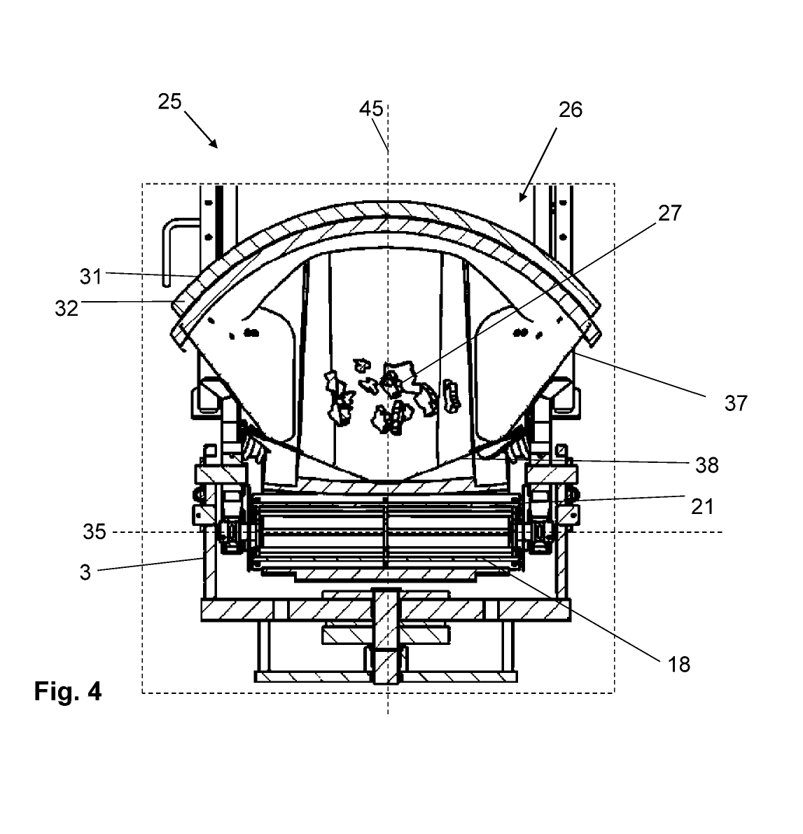

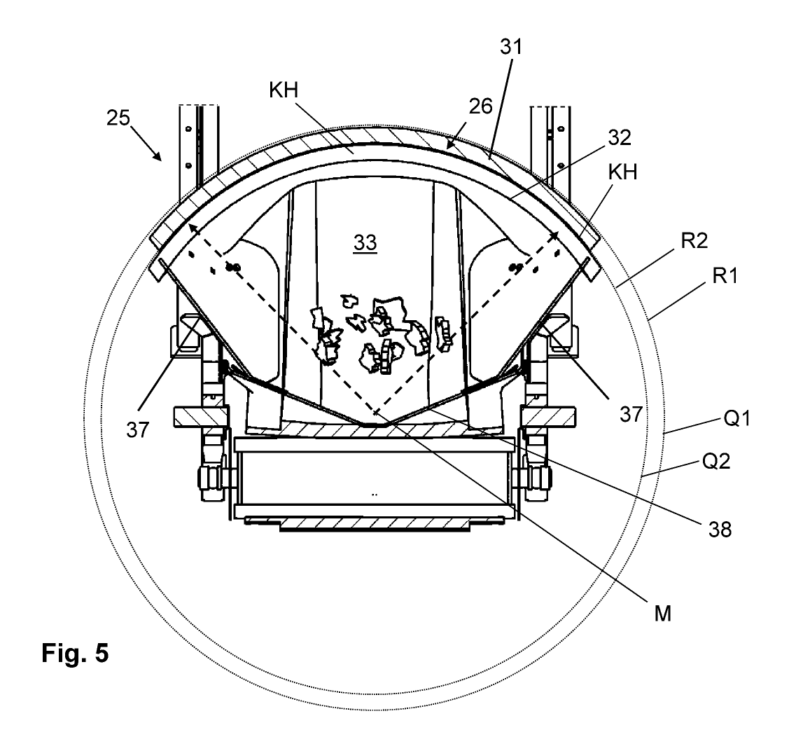

FIGS. 2 to 5 relate to various views of an especially suitable embodiment. FIG. 2 shows a vertical lateral longitudinal sectional view through the centre of the machine in an embodiment in accordance with the present invention and summarises the novelties in accordance with the present invention with respect to the area framed with reference A in FIG. 1. FIG. 3 shows a partial side view (non-sectional) of details of the area B in FIG. 2 which will be described below in closer detail. FIG. 4 shows a cross-sectional view along the line C in FIG. 2 with direction of view on the ground milling machine 10. FIG. 5 shows a detailed view of individual elements of FIG. 4. The descriptions below relate, in particular, to a summary of these FIGS. 2 to 5.

The transfer conveyor belt 17 and the loading conveyor belt 21 are respectively enclosed in the manner of a channel along their respective conveying section. The transfer conveyor belt 17 is mounted for this purpose in a conveying channel 16 within the machine frame 3, which covers the transfer conveyor belt 17 laterally and upwardly. The loading conveyor belt 21 comprises a cover 20, which also especially represents a cover of the conveying section laterally and upwardly. Both conveyor belts 17 and 21 further respectively comprise a revolving transport belt 22 and deflection pulleys 18 and support rollers 19 in the known manner for the transport of the milled material. In working operation, the milled material is ejected in a material transfer area 5 from the transfer conveyor belt 17 to the transport conveyor belt 21. This material transfer area 5 is sealed in the present case by a sealing apparatus 26 as a part of a material transfer apparatus 25 at least partly to the outside, especially towards the sides and upwardly. In other words, the sealing apparatus 26 functionally represents the connecting item between the covers 16/20 of the transfer conveyor belt 17 and the loading conveyor belt 21.

Essential components of the sealing apparatus 26 according to one embodiment are especially the two sealing elements 31 and 32. They are substantially arranged in form of a spherical cap KH, wherein they comprise further areas for fixing, for example, which no longer belong to the area of the spherical cap of the respective sealing element 31 or 32. The sealing elements 31 and 32 therefore respectively substantially correspond in their shape and contour to the section of a hollow sphere and are therefore shaped in the manner of a shell. The two sealing elements 31 and 32 are further arranged to be disposed in each other in the manner that their bulging outside is respectively the upper side and the sealing element 32 partly rests in the shell obtained by the sealing element 31. Both sealing elements 31 and 32 are therefore arranged in a mutually overlapping manner in substantial parts, wherein the sealing element 31, as seen from the outside, is placed at least partly over the sealing element 32. As a result, an interior hollow space 33 is covered in the manner of a cap by the two sealing elements 31 and 32, in which the transfer of the milled material occurs from the transfer conveyor belt 17 to the loading conveyor belt 21. The sealing element 31 is mounted on the machine frame 3 of the ground milling machine 10 and the sealing element 32 is mounted on the frame of the loading conveyor belt 21. An adjusting movement of the loading conveyor belt 21 relative to the machine frame 3 therefore also adjusts the position of the sealing element 32.

The sequence of the material transport will be described below in closer detail. Milled material 27 will be removed from the ground 11, for example, a road surface, in milling operation of the road construction machine 10 by means of the milling drum (not shown). The milled material 27 will be conveyed from the milling drum box 2 via the transfer conveyor belt 17 to the material transfer apparatus 25. The material transfer apparatus 25 is therefore supplied with milled material via the end of the transfer conveyor belt 17. This area of the material transfer apparatus is known as material feed area 39. Once the milled material 27 passes the deflection pulley 18 in the conveying direction A, it is ejected in the direction of the loading conveyor belt 21 and passes in a trajectory the interior space 33 of the material transfer apparatus 25 which is shielded by the two sealing elements 31 and 32. The milled material 27 is therefore ejected directly and free from obstructions from the transfer conveyor belt 17 onto the loading conveyor belt 21 without prior deflection by a material deflection device such as an impact plate, for example. The milled material will subsequently be transported off via a material discharge area by the loading conveyor belt 21 and finally ejected at a desired location, e.g., a truck with a suitable loading surface for removing the milled material 27.

A person situated on the operating stand 4 during the operation of the road construction machine 10 will be protected by the sealing apparatus 26 from dusting material 27 from the material transfer area 5 because the sealing apparatus 26 forms a barrier by the two stacked sealing elements 31 and 32 which prevents the escape of dust or flying particles of the milled material 27 from the transfer area to the outside ambient environment.

In this respect, the specific arrangement of the two sealing elements 31 and 32 in form of spherical caps is of major importance. The sealing elements 31 and 32 are substantially arranged as spherical caps especially in the region of their mutual overlapping (wherein in this case an overlapping of the two spherical caps is meant from the centre point of the sphere to the outside). The sphere cross sections Q1 and Q2, on which the respective spherical cap is based, are indicated in FIG. 3 (lateral sectional view) and FIG. 5 (cross-sectional view). The spherical cap of the sealing element 31 with the cross-section Q1 and the radius R1 is arranged slightly larger with respect to its radius than the sealing element 32 having the cross-section Q2 and the radius R2. The two spherical caps of the sealing elements 31 and 32 are arranged relative to one another in the manner that their centre points M rest on top of one another or are situated at one and the same point from a spatial point of view, and therefore form a common centre point M. As a result, the two sealing elements 31 and 32 can be adjusted about the centre point M with respect to each other without changing their (sealing) distance in the overlapping region in the radial direction. As a result, constant sealing results are always obtained between the two spherical halves within the provided adjustment region of both elements with respect to each other, even when the relative position of the spherical caps will change.

As already described above, the loading conveyor belt 21 is movable relative to the machine frame 3, specifically about the vertical lateral swivel axis 45 and the downward and upward swivel axis 35 which extends horizontally and transversely to the forward direction 13. The common centre point M of the two spherical caps (or the area of the sealing elements 31 and 32 arranged as a spherical cap) lies further on the lateral swivel axis 45 and also on the downward and upward swivel axis 35 or in its point of intersection. This special arrangement leads to the consequence that during an adjustment of the relative position of the loading conveyor belt 21 relative to the machine frame 3 about one or both of the axes 35 and 45 the distance of the two sealing elements 31 and 32 remains constant in the region of their spherical caps, so that no special adjustment in the position of the sealing elements 31 and 32 is necessary, for example, with respect to their fixing element (machine frame 3 or loading conveyor belt 21) for maintaining the sealing of the material transfer area 5 to the outside. Principally, the structure which approaches that of a spherical joint is obtained by the at least partial arrangement of the sealing elements 31 and 32 as spherical caps in this overlapping region.

Especially FIGS. 4 and 5 illustrate the at least partial encapsulation of the material transfer area 5 which is obtained by using the two sealing elements 31 and 32, in particular. The sealing of the material transfer area 5 upwardly and to the sides is substantially obtained by the sealing elements 31 and 32 which overlap one another in the region of their spherical caps. A lateral boundary 37 and a collecting area 38 are provided to the sides and downwardly, which also contribute at least in part to sealing the material transfer area 5 to the outside.

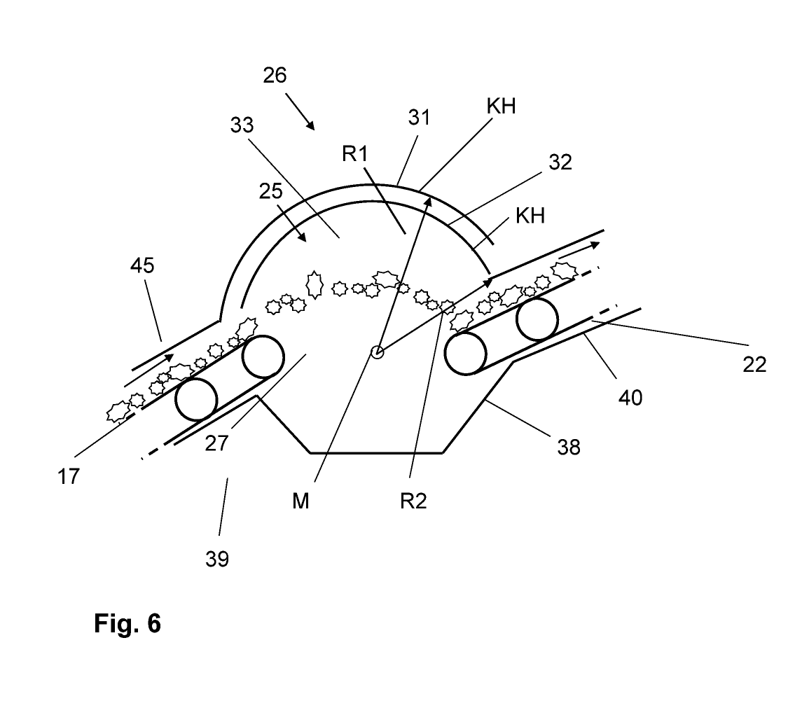

FIG. 6 shows a highly schematic view of a vertical section in the working direction of the ground milling machine 10 through the material transfer area 5 in order to further illustrate the principal functionality of the present invention. Reference is made to the explanations above, especially with respect to FIG. 2, concerning the principal arrangement of the material transfer apparatus 25. What is decisive for the arrangement of the material transfer apparatus 25 is the basic idea to arrange a sealing of the material transfer area 5 between the two conveyor belts 17 and 21 with at least two sealing elements 31 and 32 in such a way that sealing will also be maintained during a relative movement. Forms are principally possible which are suitable for only one direction of movement, for example, a pivoting movement about an axis. However, the advantages of the present invention will be especially clear when the shape of the sealing elements 31 and 32 with respect to each other is chosen in such a way that several movements are possible, for example, actuating movements about two perpendicularly extending actuating axes, while maintaining the sealing. The use of spherical cap structures in the sealing elements and the arrangement of the centre point of the spherical caps in the point of intersection of the movement or pivoting axes of the sealing elements are especially suitable in this case.

In addition to the material feed area 39 of the transfer conveyor belt 17, via which milled material 27 is conveyed into the material transfer area 5 or into the interior hollow space 33 of the two sealing elements 31 and 32, the specific configuration of the material transfer apparatus 25 comprises the material discharge area 40 of the loading conveyor belt 21, via which the milled material is transported out of and away from interior hollow space 33. The interior hollow space 33, which is encapsulated, in particular, by the sealing elements 31 and 32 towards the sides and upwardly and in which the milled material transfer occurs from the transfer conveyor belt 17 to the loading conveyor belt 21, allows a direct and unobstructed ejection of the milled material 27 onto the following conveyor belt (loading conveyor belt 21), without requiring a separate material guide device against which the milled material will be ejected according to the prior art.

The material feed area 39 and the material discharge area 40 respectively open into the hollow space 33, wherein the two orifice areas can be aligned in different ways, as is indicated, by way of example, in FIG. 6 in the vertical direction. In this case, the first material conveying means 17 is aligned at a lower angle in relation to a horizontal line in comparison with the second material conveying means 21. The sealing element 31 is further fixed to the machine frame 3 and the sealing element 32 to the loading conveyor belt 21. During a relative movement of the loading conveyor belt 21 to the machine frame 3 there will also simultaneously be a relative adjustment of the sealing elements 31 and 32 with respect to each other. The adjustment of the position of the sealing elements 31 and 32 therefore automatically occurs within the adjustment range provided for the loading conveyor belt 21, so that a separate readjustment is not necessary.

The first sealing element 31 is arranged in the vertical direction above the second sealing element 32 and covers the second sealing element at least in part. In the present example, the two sealing elements 31 and 32 have a common coverage of approximately 90% to 95% relating to their respective surface area, wherein the two surfaces differ only slightly with respect to their surface area. In this case, an outside surface of the bottom sealing element 32 can be provided with such a smooth arrangement that an inside of the sealing element 31 arranged above is in operative connection with the surface of the second sealing element 32 or slides on said surface in direct contact.

The two sealing elements 31, 32 can respectively be arranged in an integral way and can especially consist of metal and/or plastic.

The material transfer apparatus 25 with the sealing apparatus 26 in accordance with the present invention can principally be used in all machines and conveying installations on which at least two material conveying means such as conveyor belts are arranged in series. The advantages of the present invention are especially clear in ground milling machines, especially road milling machines, e.g., arranged as rear or middle rotor machines with front loading.

While the present invention has been illustrated by description of various embodiments and while those embodiments have been described in considerable detail, it is not the intention of Applicant to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of Applicants' invention.

What is claimed is:

1. A material transfer apparatus for a ground milling machine for the transfer of milled ground material, comprising:
a material feed area of a transfer conveyor belt;
a material discharge area of a loading conveyor belt; and
a sealing apparatus with a first sealing element and
at least one second sealing element, wherein the first sealing element and the second sealing element overlap each other at least in part and cover a hollow space through which milled ground material to be removed is conveyed from the material feed area to the material discharge area.

2. The material transfer apparatus according to claim 1,
wherein the two sealing elements are displaceable relative to one another.

3. The material transfer apparatus according to claim 1,
wherein the first sealing element and the second sealing element respectively substantially have the shape of a spherical cap at least in part.

4. The material transfer apparatus according to claim 3,
wherein one of the spherical caps is arranged at least partly within the interior of the other spherical cap.

5. The material transfer apparatus according to claim 3,
wherein the respective spherical caps of the first and second sealing elements have a common centre point (M), wherein the first sealing element has a first radius (R1) and the second sealing element has a second radius (R2), and wherein the two radii (R1, R2) differ from each other.

6. The material transfer apparatus according to claim 5,
wherein the material discharge area can be swivelled up and/or down about an adjusting axis in relation to the material feed area, and that the common centre point (M) lies on said axis.

7. The material transfer apparatus according to claim 5,
wherein the material discharge area is laterally pivotable about an adjusting axis in relation to the material feed area, and that the common centre point (M) lies on this axis.

8. The material transfer apparatus according to claim 1,
wherein the first sealing element is fixed to a machine frame and the second sealing element is arranged on the loading conveyor belt.

9. The material transfer apparatus according to claim 1,
wherein the first sealing element and/or the second sealing element are integrally arranged.

10. A ground milling machine, comprising:
a transfer conveyor belt for conveying milled material from a milling drum box to a loading conveyor belt;
the loading conveyor belt for conveying the milled material to an ejection point; and
a material transfer point where the material is transferred from the transfer conveyor belt to the loading conveyor belt;
wherein a material transfer apparatus according to claim 1 is installed at the material transfer point.

11. The material transfer apparatus according to claim 3,
wherein one of the spherical caps is arranged completely within the interior of the other spherical cap.

12. The ground milling machine according to claim 10,
wherein the ground milling machine comprises a road milling machine.
